(19) United States
(12) Patent Application Publication
(10) Pub. No.: US 2025/0268699 A1
(43) Pub. Date: Aug. 28, 2025

(54) SURGERY PLATFORM WITH A ROTATING SURFACE ON A STATIONARY BASE WITH INTEGRATED GAS LINES, INTEGRATED HEATING ELEMENTS, AND LEG POSITIONING STRAP SYSTEM

(71) Applicant: University of Kentucky Research Foundation, Lexington, KY (US)

(72) Inventors: Noe Tirado-Muniz, Lexington, KY (US); Mark A. Suckow, Lexington, KY (US)

(21) Appl. No.: 19/060,167

(22) Filed: Feb. 21, 2025

Related U.S. Application Data
(60) Provisional application No. 63/557,188, filed on Feb. 23, 2024.

(51) Int. Cl. A61D 3/00; A61D 7/00

(52) U.S. Cl. CPC A61D 3/00; A61D 7/00

(57) ABSTRACT

The present disclosure concerns a surgery platform with a rotating surgery surface on a stationary base with integrated transport lines for feeding power and gas to the surgical surface. In some aspects, the platform can be utilized for surgery on small animals, such as rodents. The system can include a lower stationary base which supports the rotating upper operating surface via a pillar. The integrated lines run through the base into the center pillar and up to a swivel mechanism that allows rotation without kinking/twisting of either.

### CROSS-REFERENCE TO RELATED APPLICATIONS

This application claims priority to U.S. Provisional Application 63/557,188, filed Feb. 23, 2024, the content of which is hereby incorporated by reference in its entirety.

### FIELD

This present disclosure relates to systems and methods for retaining small animals during surgical procedures.

### BACKGROUND

Surgeries require access to limited space within a subject. The type of surgery can require the angle of the surgeon to change as the procedure proceeds. Further, the access and subject size can severely hinder the surgeon's ability to adequately access the desired sites. Peripheral items, such as lighting, heating, and anesthesia to the patient are often necessary, but can crowd the surgeon's space. Thus there is a need for an adaptable surgical system that allows for improved access.

### SUMMARY

A 1^{st} aspect of the present disclosure, either alone or in combination with any other aspect herein, concerns a system for the surgery of small vertebrates comprising a stationary base, a rotatable upper surgery platform, and a pillar, wherein the pillar extends upward from the base and connects to a lower surface of the rotatable upper surgery platform.

A 2^{nd} aspect of the present disclosure, either alone or in combination with any other aspect herein, concerns the system of the 1^{st} aspect, further comprising a transport line, wherein the transport line comprises at least one of a gas line and/or an electric line and wherein the transport line passes from a distal end through the base and the pillar to a proximal end at the rotatable upper surgery platform.

A 3^{rd} aspect of the present disclosure, either alone or in combination with any other aspect herein, concerns the system of the 2^{nd} aspect, further comprising a swivel deposited along the transport line.

A 4^{th} aspect of the present disclosure, either alone or in combination with any other aspect herein, concerns the system of the 3^{rd} aspect, wherein the swivel is located within the body of the pillar.

A 5^{th} aspect of the present disclosure, either alone or in combination with any other aspect herein, concerns the system of the 2^{nd} aspect, wherein the transport line is a gas line and is operably connected to an anesthetic gas and/or oxygen gas source at the distal end and a nose cone and/or an endotracheal tube at the proximal end.

A 6^{th} aspect of the present disclosure, either alone or in combination with any other aspect herein, concerns the system of the 2^{nd} aspect, wherein the transport line is an electrical line and is operably connected at the distal end to an electric source of current.

A 7^{th} aspect of the present disclosure, either alone or in combination with any other aspect herein, concerns the system of the 6^{th} aspect, wherein the electrical line operably connected at the proximal end to a circulating water pump, a heating gel or an infrared heating pad on the upper surface of the rotatable upper surgery platform.

An 8^{th} aspect of the present disclosure, either alone or in combination with any other aspect herein, concerns the system of the 2^{nd} aspect, further comprising a water line.

A 9^{th} aspect of the present disclosure, either alone or in combination with any other aspect herein, concerns the system of the 1^{st} aspect, wherein the rotatable upper surgery platform is configured to rotate in a circular direction about a circumference of the pillar.

A 10^{th} aspect of the present disclosure, either alone or in combination with any other aspect herein, concerns the system of the 9^{th} aspect, wherein the rotatable upper surgery platform is operably rotated by an electronic or pneumatic foot pedal.

An 11^{th} aspect of the present disclosure, either alone or in combination with any other aspect herein, concerns the system of the 9^{th} aspect, wherein the rotatable upper surgery platform is operably tiltable in a vertical or horizontal direction.

A 12^{th} aspect of the present disclosure, either alone or in combination with any other aspect herein, concerns the system of the 1^{st} aspect, wherein the rotatable upper surgery platform further comprises an adjustable strap operably connected to a magnet on the upper surface.

A 13^{th} aspect of the present disclosure, either alone or in combination with any other aspect herein, concerns the system of the 1^{st} aspect, further comprising at least one of one or more mirrors positioned around a perimeter of the upper surface of the rotatable upper surgery platform, a light source, a magnification source, a pulse oximeter, an electrocardiogram, or a combination thereof.

A 14^{th} aspect of the present disclosure, either alone or in combination with any other aspect herein, concerns the system of the 1^{st} aspect, wherein a braking mechanism is operably connected to the rotatable upper surgery platform to prevent rotation and or tilting or to maintain a position of the rotatable upper surgery platform.

A 15^{th} aspect of the present disclosure, either alone or in combination with any other aspect herein, concerns the system of the 1^{st} aspect, further comprising one or more image capturing devices positioned on the upper surface of the rotatable upper surgery platform.

A 16^{th} aspect of the present disclosure, either alone or in combination with any other aspect herein, concerns the system of the 1^{st} aspect, wherein the pillar is extendible to thereby raise or lower the rotatable upper surgery platform.

A 17^{th} aspect of the present disclosure, either alone or in combination with any other aspect herein, concerns a method for performing comprising placing a subject on the system of claim 1 and rotating the rotatable upper surgery platform about the pillar.

An 18^{th} aspect of the present disclosure, either alone or in combination with any other aspect herein, concerns the method of the 17^{th} aspect, wherein the system further comprises a gas line and an electric line with a swivel disposed along each, wherein the gas line and is operably connected to an anesthetic gas and/or oxygen gas source and wherein the electric line is operably connect to a power source.

A 19^{th} aspect of the present disclosure, either alone or in combination with any other aspect herein, concerns the method of the 18^{th} aspect, wherein the electric line is operably connected to a heating pad on the rotatable upper surgery platform.

### BRIEF DESCRIPTION OF THE DRAWINGS

FIG. 1 shows a rotating surgery surface on a stationary base with an integrated anesthetic/O₂ gas line, integrated electrical heating element, magnetic limb positioning strap system and optional light source and/or magnification.

FIG. 2 shows the system including a lower stationary base which supports the rotating upper operating surface via a pillar.

FIG. 3 shows the adjustable strap and anchoring that allows for repositioning/adjustment for the subject size and/or needs.

### DESCRIPTION

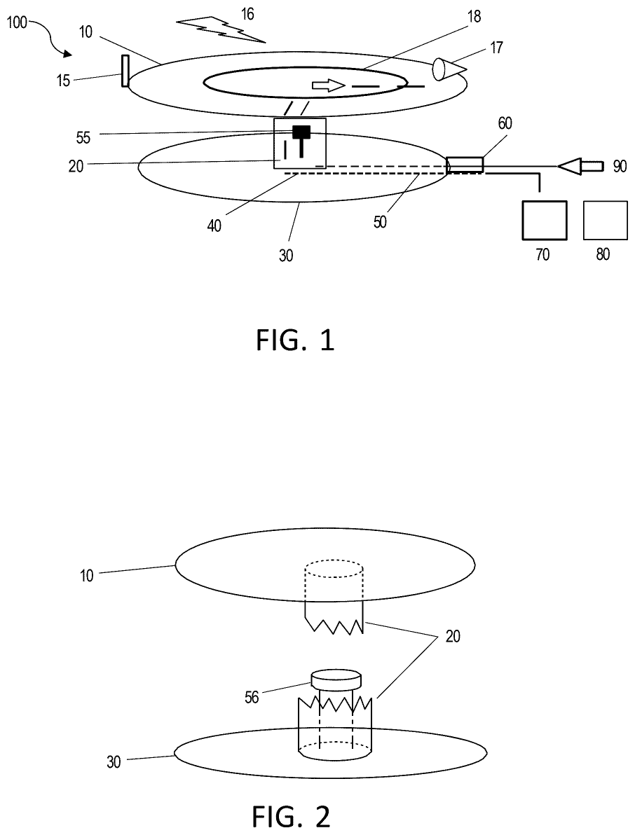

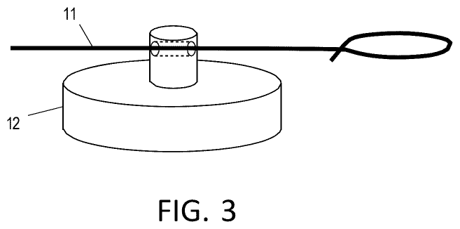

The present disclosure concerns systems and methods to provide a rotatable surgical platform for small animals. In some aspects, the present disclosure concerns a surgery platform with a rotating surgery surface on a stationary base with integrated anesthetic/O₂ gas lines, integrated electrical heating elements, magnetic leg positioning strap system and optional light source and magnification (FIG. 1). The present disclosure concerns a surgery platform with a rotating surgery surface on a stationary base with integrated anesthetic/O2 gas lines, integrated electrical heating elements, magnetic leg positioning strap system and optional light source and magnification (see, e.g., FIG. 1). In some aspects, the platform can be utilized for surgery on rodents. The system can include a lower stationary base which supports the rotating upper operating surface via a pillar (FIG. 2). The base includes a port to attach both anesthetic gas/oxygen and electrical power supply. The integrated lines (e.g. anesthetic gas and power) run through the base into the center pillar and up to a swivel mechanism that allows rotation without kinking/twisting of either the gas or the electrical components. The swivel system connects integrated anesthetic gas and electrical power lines to the upper rotating operating platform. The power line feeds either a water (via a circulating water pump), gel “bed” or infrared pad located towards the center of the platform to keep the animal warm during the procedure. The gas line delivers anesthetic and oxygen to the patient via a nose cone or endotracheal mask/tube. The operating platform has a detachable handle made of autoclavable material and which can be used to rotate the platform. The platform may also be rotated by means of an electronic foot-pedal. In addition to rotating in a circular plane, the platform may also be tilted vertically or horizontally. Any rotation of the platform includes a hold mechanism so that the orientation of the platform is held in place while being used. The patient is placed on the rotating table and held in position using straps made of materials such as nylon and anchored by magnets that can be repositioned/adjusted depending on the patient size and procedure needs (FIG. 3). This system would allow the surgeon to rotate the patient in a circular plane for ease of manipulation while maintaining the sterile field, without disrupting the constant delivery of anesthetic gas/O2. It also allows the surgeon an easier approach to rodent surgery in a more ergonomic fashion decreasing fatigue, improving productivity and potentially decreasing negative surgery outcomes.

Turning to FIG. 1, the system 100 includes a rotatable upper surgery platform 10 positioned on top of a pillar 20 that in turn extends from a stationary base 30. The pillar 20 connects to a lower surface of the rotatable upper surgery platform 10 in a manner such that the rotatable upper surgery platform 10 rotates about a central y axis through the pillar 20. In some aspects, the rotatable upper surgery platform 10 is of a circular shape, though such is not required, but merely renders rotation balanced. The stationary base 30 which supports the rotatable upper surgery platform 10 via the pillar 20. The stationary base 30 includes a port 60 to attach both anesthetic gas/oxygen and electrical power supply. In some aspects, the rotatable upper surgery platform 10 can be raised and/or lowered, such as through the pillar 20 being configured to extended in length.

In some aspects, the system and methods of the present disclosure provide for transport lines to run from the exterior of the system to the rotatable upper surgery platform 10. Transport lines may include a gas line 50 and/or an electric line 40 or similar, such as a water line (not shown). Connected to the stationary base 30 through a connection port 60 are a gas line 50 and an electric line 40, as well as any other transport lines, that feed through the stationary base 30 and up through the interior of the pillar 20 to reach the rotatable upper surgery platform 10. In order to avoid kinking in the gas line 50 and/or the electric line 40 as the rotatable upper surgery platform 10 rotates about the pillar 20, one or more swivel(s) 55 can be introduced along the length of each line to thereby effectively allow the gas line 50 and the electric line 40 to freely rotate about the same y-axis as the rotatable upper surgery platform 10.

The swivel(s) 55 in the gas line 50 and/or the electric line 40 allow for the flow of gas and/or electricity to an upper surface of the rotatable upper surgery platform 10 from stationary sources outside or beside the system 100. It is a difficulty in translating a need for gas and/or electrical power to a small animal surgical surface while still being able to provide rotation thereof, the options are to either provide the gas and/or power on the surgical surface or to severely limit the rotation of the surgical surface. The placement of a swivel 55 allows both obstacles to be overcome, freeing the surgery surface for access to the subject on the upper surface thereof. The integrated lines (e.g. anesthetic gas and power) run through the base into the center pillar and up to a swivel mechanism that allows rotation without kinking/twisting of either the gas or the electrical components.

In some aspects, the gas line 50 can run a gas source 80 through a control 90 and connection port 60 into the system 100, wherein it runs through the stationary base 30 through the interior of the pillar 20 and up to the rotatable upper surgery platform 10 through a swivel 55. On the upper surface of the rotatable upper surgery platform 10, the gas line 50 can be operably connected to a breathing apparatus 17 such as an intubation tube or a breathing mask to supply the gas from the gas line 50 to the subject on the rotatable upper surgery platform 10. The gas of the gas line 50 can be oxygen (O₂), an anesthetic gas, or a combination. The gas can include air or filtered air. The gas can be pressurized. The gas line 50 can optional include common features such as pressure regulators, valves, and such further along the length thereof.

Similarly, the electric line 40 connects a power source 70 to the rotatable upper surgery platform 10 in a similar pathway. The electrical line 40 may be operably connected to one or more end points on the rotatable upper surgery platform 10, such as an integrated heating element 18. In some aspects, the electric line 40 can be operably connected to a water pump. Additional transport lines such as a water line (not shown) can similarly use a swivel 55 to provide water to the rotatable upper surgery platform 10. A water line can be operably connected to a pump to provide a stream of water. A water line can be operably connected to a valve to control the flow of water.

Turning to FIG. 2, shown a cut away view of the pillar 20 with a swivel platform 56 in the interior space therein. The swivel platform 56 provides a plate upon which the rotatable upper surgery platform 10 can rotate. Thus the pillar 20 need not rotate itself, but instead provide the structural support to the rotatable upper surgery platform 10 while the swivel platform 56 provides the axis of rotation.

Turning back to FIG. 1, the rotatable upper surgery platform 10 can be of a sufficiently small surface area as needed for the subject being operated on. The transport lines of the gas line 50 and the electric line 40, being able to be connected to off platform sources (via the swivel(s) 55) frees the surface area. The

A system for the surgery of small vertebrates comprising a stationary base, a rotatable upper surgery platform, and a pillar, wherein the pillar extends upward from the base and connects to a lower surface of the rotatable upper surgery platform. Rotation of the rotatable upper surgery platform 10 can be either manually or electrically or pneumatically controlled, or through a combination thereof. For example, a handle 15 can be placed on the rotatable upper surgery platform 10 to allow for the rotation thereof about the pillar 20 and/or swivel platform 56 therein. In some aspects, the handle 15 is detachable such that it can be sterilized and/or cleaned, such as with an autoclave. A device such as a foot pedal (not shown) can connect pneumatic or electric energy to a motor (not shown) operably connected to the rotatable upper surgery platform 10 (such as through the swivel platform 56) to cause rotation thereof. It is a further feature that the rotatable upper surgery platform 10 be operably connected to a braking or rotation damping system (not shown) to cause the rotation thereof to halt and/or to maintain the rotatable upper surgery platform 10 in a particular position.

In some aspects, the rotatable upper surgery platform 10 can be adjusted additionally to tilt either vertically and/or horizontally. In further aspects, the system may include means to maintain the rotatable upper surgery platform 10 in a desired titled position.

In some aspects, the rotatable upper surgery platform 10 can feature additional features on or about the upper surface thereof. Such may include a camera or similar image capture device (not shown). Such may include a light source (not shown). Such may include a source for magnification (not shown) to allow a user to better visualize the surgical procedure(s) on the subject. Such may include one or more surgical instrument holders and/or rests (not shown). Such may include connections or the ability to receive additional surgical monitoring systems (not shown) such as a pulse oximeter, an ECG (electrocardiogram) machine or leads thereto.

In some aspects, the rotatable upper surgery platform 10 may be made at least in part of a ferromagnetic material, such as a steel, including surgical steel. As shown in FIG. 1, such can offer magnetic attachments 16 to the upper surface of the rotatable upper surgery platform 10. In some aspects, a magnet can be used to assist in restraining the subject during a surgical procedure.

Turning to FIG. 3, shown is a magnetic restraint to limit the movement of a subject's limb during a procedure. The restrain includes a magnet 12 and a loopable material 11 that affixes to the magnet 12. For example, as depicted, the magnet 12 includes a hole through which the loopable material 11 can be threaded. The loopable material 11 can be looped around the limb of a subject (not shown) to effectively tie the limb to the magnet 12. The attracting between the magnet 12 and the ferromagnetic material of the rotatable upper surgery platform 10 allows for the limb to effectively be tied to the rotatable upper surgery platform 10. It will be appreciated that use of multiple such restraints will allow for multiple limbs to be retrained. For example, four of such restraints will allow for all four limbs of a small mammal to be restrained.

The present disclosure also includes methods of using the system to perform a surgical procedure on a subject. While the subject can be any animal, it is a distinct advantage that through the integrated transport lines of the present system, the system can accommodate small animals, such as small mammals, including rodents and the like. The present system allows the surgeon to rotate the patient in a circular plane for ease of manipulation while maintaining the sterile field, without disrupting the constant delivery of anesthetic gas/O₂. The present system also allows the surgeon an easier approach to surgery on small animals in a more ergonomic fashion decreasing fatigue, improving productivity and potentially decreasing negative surgery outcomes.

In some aspects, the methods include use of the magnet(s) 12, the loopable material 11, and the rotatable upper surgery platform 10. A limb of the subject is looped through the loopable material 11 and the magnet 12 adheres to the upper surface of the rotatable upper surgery platform 10.

In some aspects, the methods include flowing a gas such as an anesthetic gas and/or O₂ through the gas line 50. At a proximal end of the gas line 50 on the rotatable upper surgery platform 10, the gas line 50 is operably connected to a breathing apparatus such as an intubation tube or a mask that delivers the gas to the subject.

In some aspects, the methods include providing heat to the subject during a surgical procedure. For example, a proximal end of the electrical line 40 is operably connected to a heating pad 18 on the rotatable upper surgery platform 10. The heating pad 18 thereby provides heat to the body of a subject on top thereof.

Various modifications of the present disclosure, in addition to those shown and described herein, will be apparent to those skilled in the art of the above description. Such modifications are also intended to fall within the scope of the appended claims.

It is appreciated that all reagents are obtainable by sources known in the art unless otherwise specified.

It is also to be understood that this disclosure is not limited to the specific aspects and methods described herein, as specific components and/or conditions may, of course, vary. Furthermore, the terminology used herein is used only for the purpose of describing particular aspects of the present disclosure and is not intended to be limiting in any way. It will be also understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein. Similarly, as used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Reference is made in detail to exemplary compositions, aspects and methods of the present disclosure, which constitute the best modes of practicing the disclosure presently known to the inventors. The drawings are not necessarily to scale. However, it is to be understood that the disclosed aspects are merely exemplary of the disclosure that may be embodied in various and alternative forms. Therefore, specific details disclosed herein are not to be interpreted as limiting, but merely as a representative basis for any aspect of the disclosure and/or as a representative basis for teaching one skilled in the art to variously employ the present disclosure.

Patents, publications, and applications mentioned in the specification are indicative of the levels of those skilled in the art to which the disclosure pertains. These patents, publications, and applications are incorporated herein by reference to the same extent as if each individual patent, publication, or application was specifically and individually incorporated herein by reference.

The foregoing description is illustrative of particular embodiments of the disclosure, but is not meant to be a limitation upon the practice thereof. The following claims, including all equivalents thereof, are intended to define the scope of the disclosure.

We claim:

1. A system for the surgery of small vertebrates comprising a stationary base, a rotatable upper surgery platform, and a pillar, wherein the pillar extends upward from the base and connects to a lower surface of the rotatable upper surgery platform.

2. The system of claim 1, further comprising a transport line, wherein the transport line comprises at least one of a gas line and/or an electric line and wherein the transport line passes from a distal end through the base and the pillar to a proximal end at the rotatable upper surgery platform.

3. The system of claim 2, further comprising a swivel deposited along the transport line.

4. The system of claim 3, wherein the swivel is located within the body of the pillar.

5. The system of claim 2, wherein the transport line is a gas line and is operably connected to an anesthetic gas and/or oxygen gas source at the distal end and a nose cone and/or an endotracheal tube at the proximal end.

6. The system of claim 2, wherein the transport line is an electrical line and is operably connected at the distal end to an electric source of current.

7. The system of claim 6, wherein the electrical line operably connected at the proximal end to a circulating water pump, a heating gel or an infrared heating pad on the upper surface of the rotatable upper surgery platform.

8. The system of claim 2, further comprising a water line.

9. The system of claim 1, wherein the rotatable upper surgery platform is configured to rotate in a circular direction about a circumference of the pillar.

10. The system of claim 9, wherein the rotatable upper surgery platform is operably rotated by an electronic or pneumatic foot pedal.

11. The system of claim 9, wherein the rotatable upper surgery platform is operably tiltable in a vertical or horizontal direction.

12. The system of claim 1, wherein the rotatable upper surgery platform further comprises an adjustable strap operably connected to a magnet on the upper surface.

13. The system of claim 1, further comprising at least one of one or more mirrors positioned around a perimeter of the upper surface of the rotatable upper surgery platform, a light source, a magnification source, a pulse oximeter, an electrocardiogram, or a combination thereof.

14. The system of claim 1, wherein a braking mechanism is operably connected to the rotatable upper surgery platform to prevent rotation and or tilting or to maintain a position of the rotatable upper surgery platform.

15. The system of claim 1, further comprising one or more image capturing devices positioned on the upper surface of the rotatable upper surgery platform.

16. The system of claim 1, wherein the pillar is extendible to thereby raise or lower the rotatable upper surgery platform.

17. A method for performing comprising placing a subject on the system of claim 1 and rotating the rotatable upper surgery platform about the pillar.

18. The method of claim 17, wherein the system further comprises a gas line and an electric line with a swivel disposed along each, wherein the gas line and is operably connected to an anesthetic gas and/or oxygen gas source and wherein the electric line is operably connect to a power source.

19. The method of claim 18, wherein the electric line is operably connected to a heating pad on the rotatable upper surgery platform.
